(19) United States
(12) Patent Application Publication
(10) Pub. No.: US 2009/0209723 A1
(43) Pub. Date: Aug. 20, 2009

(54) POLYURETHANE RESINS, A METHOD FOR THE PRODUCTION THEREOF AND OPTICAL LENSES MADE OF SAID RESINS

(76) Inventors: Noemie Lesartre, Charenton-le-Pont (FR); Fabien Berit-Debat, Cgarebtib-le-Pont (FR)

Correspondence Address: OCCHIUTI ROHLICEK & TSAO, LLP, 10 FAWCETT STREET, CAMBRIDGE, MA, 02138, US

(21) Appl. No.: 11/718,002

(22) PCT Filed: Oct. 26, 2005
(86) PCT No.: PCT/FR05/02685

§ 371 Date: Apr. 6, 2009

(30) Foreign Application Priority Data
Oct. 26, 2004 (FR) 04/11405

(51) Int. Cl. C08G 18/32; B29D 11/00; G02C 7/02

(52) U.S. Cl. 528/60; 264/2.6; 351/159

(57) ABSTRACT

The invention relates to polyurethane resins for producing impact-resistant optical lenses, in particular ophthalmic lenses made by using said resins and to a method for producing said lenses, in particular for using thermosetting polyurethane resin for producing the optical lenses, wherein said resin comprises a part (I) corresponding to an isocyanate part containing. A) a methylene-bis-4,4′-isocyanatecyclohexane (Hi2MDI), b) a prepolymer obtainable by the reaction between propoxilated glycerol and a methylene-bis-4,4′-diisocyanatecyclohexane and a part (II) corresponding to an alcohol part containing: c) an alkoxylated etherate glycerol in the monomer and oligomer form thereof and d) at least one type of a polyalkoxylated tertiary diamine tetraol and/or triol.

The subject of the present invention is the use of polyurethane resins to manufacture impact-resistant optical lenses, the optical lenses, in particular ophthalmic lenses, obtained by using these resins, and the method for manufacturing said lenses.

The term “optical lens” is understood to mean especially ophthalmic lenses, and lenses for optical instruments.

The term “ophthalmic lens” is understood to mean lenses fitting in a spectacle frame for protecting the eye and/or correcting the vision, these lenses being chosen from afocal, unifocal, bifocal, trifocal and progressive lenses.

The term “substrate” is understood to mean the base constituent transparent material of the optical lens and more particularly of the ophthalmic lens. This material serves as support for the multilayer stack of one or more treatments, and contributes to creating the corrective function of the lens in the case of a corrective ophthalmic lens.

The term “treatment” is understood to mean any coating which may be in contact with the substrate, and/or with another coating, and which may especially be an antireflection coating, an antisoiling coating, an impact-resistant primer, an antiscratch coating and/or a polarizing coating.

A substrate, in order to fulfill its purpose, must have all the following characteristics:
a high transparency (transmission generally greater than 85%, and preferably greater than or equal to 90%), with an absence of or possibly very low light scattering;
a low yellowness index and an absence of yellowing over time;
a high impact strength according to the current standards;
a good aptitude for the various treatments (deposition of antireflection coatings, antisoiling coatings, impact-resistant primers, antiscratch coatings, polarizing coatings, etc.), and in particular a good colorability; and
a glass transition temperature (T_{g}) value greater than or equal to 80° C., preferably greater than 90° C., and very preferentially between 90°C. and 120° C.

Moreover, the thermosetting resins that form the optical lens substrate must be easy to use from an industrial standpoint. Within this context, the curable resin used according to the invention is particularly advantageous. This is because the constituent components of this resin are miscible at room temperature and have a low viscosity. These features make it possible, in particular, to formulate the polyurethane by simple mixing of the constituents at room temperature, and to cast the mixture in a suitable mold, at a temperature of 18 to 60° C., preferably 18 to 50° C., very preferentially 20 to 40° C., even more preferentially at room temperature. The manufacturing method is therefore simple, fast, reproducible and of low economic cost, the heating cycles being short and at not very high temperatures.

Thermosetting polyurethane resins are known to a person skilled in the art as being suitable for manufacturing optical lenses, especially because these resins generally have an acceptable impact strength. Thus, patent U.S. Pat. No. 6,127,505 describes a polyurethane/urea resin prepared from a prepolymer, obtained by mixing aliphatic or cycloaliphatic diisocyanate with a glycol, and with aromatic diamines. The preparation of the prepolymer itself is carried out under heating conditions between 100° C. and 140° C. for a period of 3 to 5 hours, and mixing of the prepolymer with the amine requires at least one heating step at a temperature of around 75° C.

The method for manufacturing optical lenses according to the present invention differs from the prior art in particular in that the step of mixing the two compositions enabling the thermosetting polyurethane resin to be formed and also the curing step are carried out at temperatures largely below those used in the methods of the prior art. The method of manufacturing an optical lens according to the invention therefore proves to be easier to implement and benefits from a significant economic advantage.

The optical lens substrate according to the invention has, in addition, an excellent impact strength, is easy to color, and may be easily coated under usual conditions. This resin therefore constitutes a material of choice as a substrate for an optical lens, and more particularly as a substrate for an ophthalmic lens.

A first subject of the invention therefore relates to the use, for manufacturing optical lens, of a thermosetting polyurethane resin comprising:
a part (I), corresponding to the isocyanate part, comprising:
   a) 4,4′-methylene-bis-(isocyanatecyclohexane) (H₁₂MDI);
   b) prepolymer derived from the reaction between propoxylated glycerol and 4,4′-methylene-bis-(diisocyanatecyclohexane);
a part (II), corresponding to the alcohol part, comprising:
   c) alkoxylated glycerol etherate in its monomer and oligomer form;
   d) at least one polyalkoxylated tertiary diamine tetraol and/or triol.

Part (II) has a viscosity between 900 and 2500 mPa·s, preferentially between 900 and 1800 mPa·s inclusive, and part (I) has a viscosity between 300 and 1000 mPa·s inclusive.

In part (I) of the formulation, the component (b) provides from 5- to 15% inclusive, and preferably 10%, of urethane functional groups relative to all the isocyanate functional groups present in part (I).

In the part (II) of the formulation, the alkoxylated glycerol etherate (c) is of formula (C):

HO—(R₁—O)ₙ—CH₂—CH(—(O—R₂)ₘ—OH)—CH₂—(O—R₃)ₚ—OH (C)

in which:
R₁, R₂ and R₃, being identical or different, independently of one another, represent a linear or branched (C₂-C₄) alkylene group; and
n, m and p, being identical or different, independently of one another, represent an integer between 1 and 6 inclusive.

The preferred compounds of formula (C) according to the invention are those for which:
R₁, R₂ and R₃, being identical, represent an ethylene group or an isopropylene group; and
n, m and p, being identical, represent an integer between 1 and 3 inclusive.

According to one particularly advantageous variant of the invention, the part (c) of part (II) of said resin comprises the compounds of formula (C) in which:
R₁, R₂ and R₃, being identical, represent an isopropylene group;
n, m and p, being identical, represent an integer between 1 and 3 inclusive; and
the ratio between the monomer form (n=m=p=1) and the oligomer forms (n=m=p>1) is between 100/0 and 90/10 inclusive.

In part (II) of said resin, part (d) comprises at least one polyalkoxylated tertiary diamine tetraol and/or triol of formula (D):

R₄—N(R₅)—R₈—N(R₇)—R₆ (D)

in which:
R₄, R₅ and R₆, being identical or different, independently of one another, represent a group of formula (D1):

—(R₉—O)ᵤ—(R₁₀—O)ᵥ—H (D1)
in which:
R₉ and R₁₀, being identical or different, independently from one another, represent a group chosen from ethylene, n-propylene and isopropylene;
u and v, being identical or different, independently from one another, represent an integer between 0 and 3 inclusive, it being understood that u and v do not represent the value 0 at the same time;
R₇ represents a hydrogen atom or an R₄ group as defined previously; and
R₈ represents a linear or branched (C₂-C₄) alkylene group.

The preferred compounds of formula (D) according to the invention are those for which:
R₈ represents an ethylene group;
R₄, R₅ and R₆ are identical and as defined previously;
R₇ is as defined previously; and
R₉ and R₁₀ are different and as defined previously.

According to one advantageous variant of the invention, part (d) of the part (II) of said resin comprises:
i. at least one polyalkoxylated tertiary diamine tetraol of formula (D) in which:
   R₄, R₅, R₆ and R₇, being identical, each represent a group of formula (D1) in which:
      R₉ represents an ethylene group;
      R₁₀ represents an isopropylene group;
      u and v, being identical or different, independently of one another, represent an integer between 1 and 3 inclusive;
   R₈ represents an ethylene group;
ii. possibly one or more polyalkoxylated tertiary diamine triol(s) of formula (D) in which:
   R₄, R₅ and R₆ each represent a group of formula (D1) in which:
      R₉ represents an ethylene or isopropylene group;
      R₁₀ represents an isopropylene or ethylene group;
      u and v, being identical or different, independently of one another, represent an integer between 1 and 3 inclusive;
   R₇ represents a hydrogen atom;
   R₈ represents an ethylene group; and
iii. the ratio between (i) and (ii) is between 100/0 and 90/10 inclusive.

Within the scope of the invention, the polyurethane resin comprises the part (II) for which the ratio between part (c) and part (d) is between 70/30 and 95/5 inclusive, preferentially between 75/25 and 90/10 inclusive, and very preferentially is equal to 80/20.

The molar ratio between part (I) and part (II) of said resin is between 0.95 and 1.1.

Surprisingly, in view of the optical lens processing, the thermosetting polyurethane resin used in accordance with the invention generates a substrate having a high impact strength.

One of the critical points for obtaining a high impact-strength thermosetting material is optimizing the compromise between a high T_{g} (glass transition temperature) of the material and good impact strength of said material.

Thus, obtaining a high T_{g} is desirable in order to obtain a rigidity of the substrate that prevents it deforming during the application of treatments; a high T_{g} is generally obtained by introducing rigid segments into the resin that relax at high T_{g}.

The impact-resistance feature is generally obtained by introducing flexible chains into the resin that relax at low T_{g} or via the decrease of the crosslink density of the polymer material contained in the resin. This is because an increase in the crosslink density of the polymer has the result of restricting the mobility of the polymer chains and leads to a decrease in the flexibility of the resin. This loss of flexibility has the result of decreasing the impact strength of the resin, especially due to the fact that the ability of the resin to cushion impacts by dissipating the induced energy is lowered.

A compromise should therefore be found between these two features that require materials having conflicting properties.

As described previously, the polyurethane resin used in accordance with the invention is composed of two entities: part (I) and part (II), the part (I) corresponding to the isocyanate part, and the part (II) corresponding to the alcohol part and in particular comprising at least one polyalkoxylated tertiary diamine tetraol and/or triol (d). The presence of at least one trifunctional or tetrafunctional hydroxyl-group-containing tertiary amine leads to the formation, by reaction with the isocyanate functional groups of part (I), of a highly crosslinked polyurethane resin.

The resin used in accordance with the invention is therefore both highly crosslinked, has a high T_{g} and, against all expectations, also has good impact strength.

In addition, the resin used in accordance with the invention is very simple to process, due especially to the fact that the components which constitute it are miscible at room temperature and have a low viscosity that makes casting easy.

The properties of part (II) of the resin used according to the invention are particularly important for lowering the overall viscosity of the part (I)+part (II) mixture.

The room temperature miscibility and also the low viscosity of this polyurethane resin make it a material of choice for then being used in a traditional casting process, a RIM (Reaction Injection Molding) or RTM (Reaction Transfer Molding) process.

According to a preferred embodiment of the invention, the resin used is the PX521HT resin sold by Axson.

The polyurethane resin used in accordance with the invention may also comprise additives conventionally used in thermosetting resins for casting optical lenses, in particular ophthalmic lenses in conventionally used amounts. Among the additives, mention may be made, by way of indication and nonlimitingly, of colorants, color stabilizers, optical brighteners, UV absorbers, antioxidants, anti-yellowing agents and demolding agents.

Among the demolding agents that can be used within the scope of the invention, mention may especially be made of trimethylchlorosilane, chloromethyltrimethylsilane, chloropropyltrimethylsilane, chloromethyldodecyldimethylsilane, (3,3-dimethylbutyl)dimethylchlorosilane, hexamethyldisilazane, octamethyltetrasilazane, aminopropyldimethylpolydimethylsiloxane, [3-(trimethoxysilyl)propyl]octadecyldimethylammonium chloride, [3-(trimethoxysilyl)propyl]-tetradecyldimethylammonium chloride, trimethylethoxysilane and octadecyltrimethoxy-silane.

Among the antioxidants that can be used, generally in amounts ranging up to 50 by weight relative to the total weight of reactants, mention may especially be made of polyfunctional and hindered phenolic antioxidants.

Among the UV stabilizers, mention may especially be made of benzotriazoles.

Another subject of the invention is an optical lens substrate, in particular an ophthalmic lens substrate, characterized in that it is capable of being obtained from a thermosetting polyurethane resin as defined above, said resin having been molded then cured.

The substrate according to the invention may be coated with various layers such as: an abrasion-resistant coating; an adhesion primer; an antireflection coating, antisoiling coating or polarizing coating. It may also be colored using conventional techniques.
(c) alkoxylated glycerol propoxylate in its monomer and oligomer form, the ratio between the monomer form and the oligomer forms being between 99/1 and 90/10;
(d) propoxylated and ethoxylated ethylenediamine tetraol and triol; and
(e) the ratio of (c) to (d) being between 78/22 and 82/18.

### Ophthalmic Lens Preparation Examples:

By manual casting.

Parts (I) and (II) were homogenized and degassed separately under an inert atmosphere and at room temperature (about 20° C.).

The following steps were then carried out:
Weighing of 16.67 g of part (I) into a glass flask placed in a thermostatic bath at room temperature.
Withdrawal of 9.17 g of part (II) into a syringe.
Mixing of (I) and (II) in the glass flask. Homogenization and degassing of the reactant mixture for 5 minutes at room temperature.
Withdrawal of about 15 ml of reactant mixture using a syringe. Filling a taped assembly (composed of two glass molds).
Cure cycle in the oven.

Temperature rise from 80° C. to 130° C. over 30 minutes. Hold at 130° C. for 6 hours. Return to 80° C. in 30 minutes. Disassembly of the cured substrate and annealing at 130° C. for 2 hours (removal of residual stresses).

### Using an RTM (Reaction Transfer Molding) Type Machine

This is a two component casting machine operating at low pressure. The machine was supplied by DOPAG (ELDOMIX™ model).

A further subject of the invention is a method for simply and economically manufacturing an optical lens, in particular an ophthalmic lens, from the polyurethane resin obtained by the formulation of part (I) and part (II), characterized in that it comprises a step of manufacturing the substrate, in which parts (I) and (II) of the resin as defined above are mixed, at a temperature between 18° C. and 60° C. inclusive, preferentially between 18° C. and 50° C. inclusive, very preferentially between 20° C. and 40° C. inclusive, a mold suitable for manufacturing optical lenses is filled with the resin obtained, said mold-filling being carried out manually or mechanically, then the resin placed in the mold is cured, preferably between 80° C. and 130° C. inclusive, and then an annealing step is carried out.

The examples that follow illustrate, nonlimitingly, the use of a resin in accordance with the invention, and the manufacture of a substrate for an optical lens.

### EXAMPLES

Use of the PX521HT resin sold by Axson.

The PX521HT resin falls within the scope of the polyurethane resin formulation as described previously. This resin is obtained by polymerizing:
a part (I), corresponding to the isocyanate part, comprising:
   (a) 4,4-methylene-bis(isocyanatecyclohexane) (H₁₂MDI);
   (b) prepolymer derived from the reaction between propoxylated glycerol and 4,4-methylene-bis(diisocyanatecyclohexane) (a), (b) being present at a molar ratio of 10% of urethane functional groups relative to all the isocyanate functional groups present in part (I);
a part (II), corresponding to the alcohol part, comprising at least:

Part (I) and part (II) were degassed and heated respectively in separate tanks I and II.

During casting of a substrate, the reactants were carried to the mixing head by gear pumps and also by the pressurization of the tanks (about 2-3 bar). The pipes that brought the reactants from the tanks to the “product collector” were also heated. The stoichiometry was obtained by controlling the rotational speed of each of the pumps. The total flow rate was adjusted by a control dial that acted simultaneously on the rotational speed of the two gear pumps (the relative speed of the two pumps remained unchanged and consequently the stoichiometry was not modified).

The “product collector” assembly and mixer formed the mixing head.

The alcohol reactants (part (II)) and isocyanate reactants (part (I)) were brought into contact and homogenized in the mixer known as a “static-dynamic” mixer by a person skilled in the art. The core of the mixer was driven by a variable speed pneumatic turbine.

### Parameters of the DOPAG Casting Machine for Formulation PX 521 HT:

Filtration:

Filter size: 1.2 microns

Temperature of the tanks (I) and (II): 40° C.

Temperature of the pipes (I) and (II): 50° C.

Stirring while operating

Filtration time: 4 hours

Degassing:

Temperature of the tanks (I) and (II): 40° C.

Temperature of the pipes (I) and (II): 50° C.

Stirring while operating

Degassing time: 4 hours

Casting:

Pressure of the tanks (I) and (II): 3 bar

Temperature of the tanks (I) and (II): 40° C.

Temperature of the pipes (I) and (II): 50° C.

(I)/(II) ratio: 62%

Casting flow rate: 0.12 liter/min

Stirring while operating

Speed of the static-dynamic mixer: maximum

Cure and annealing cycle identical to manual casting.

### Features of PX521HT as an Optical Lens Substrate:

| | | | |
|---|---|---|---|
| d = 1.13 | n_{D} = 1.5066 | v_{D} = 54 | T_{g} = 120° C. |

Impact strength:

| | | Center | |
|---|---|---|---|
| | dioptre | thickness | E (mJ) |
| CBI test/bare substrate | −2.00 | 1.54 | >6500 |
| CBI test/substrate + HC* | −2.00 | 1.47 | 1759 |
| CBI test/substrate + HC* + AR** | −2.00 | 1.49 | 4839 |

| | |
|---|---|
| HVI test | Pass |

*HC: Hard Coat = EP 0 614 957 + U.S. Pat. No. 5,316,791
**AR: Anti-reflection coating = nSD
E = average fracture energy.

### Description of the CBI and HVI Tests:

CBI Test (Standard ANSI 780)

The CBI test is an instrumented drop ball test. The CBI test uses 3 impacters (40 g-210 g-520 g), the choice of impacter is determined by the equipment depending on the characteristics of the glass tested. An impacter is dropped on the geometric center of the glass to be tested. The impact speed is 5 m/s. In the course of the impact, a sensor located in the ball constantly measures the force applied and the bending of the glass. The physical unit followed is the energy at any moment of impact. When the glass breaks, at this precise instant, the software gives the fracture energy of the glass. The CBI test carries out a single impact per glass, the glasses must not be retested, the glass must break each time.

A value of the fracture energy corresponds to each glass.

HVI Test

Verification of the conformity of a product to the HVI (High Velocity Impact) test described in the standard ANSI Z87.1.

A steel ball 6.35 mm in diameter is projected onto the lens tested with a speed of 150 ft/s.

The lens passes the test if it does not break.

This yes/no test is destructive.

1. The use of a thermosetting polyurethane resin for manufacturing optical lenses, characterized in that said resin comprises:
a part (I), corresponding to the isocyanate part, comprising:
a) 4,4′-methylene-bis(isocyanatecyclohexane) (H₁₂MDI);
b) prepolymer derived from the reaction between propoxylated glycerol and 4,4′-methylene-bis-(diisocyanatecyclohexane);
a part (II), corresponding to the alcohol part, comprising:
c) alkoxylated glycerol etherate in its monomer and oligomer form;
d) at least one polyalkoxylated tertiary diamine tetraol and/or triol.

2. The use as claimed in claim 1, characterized in that:
said part (II) has a viscosity between 900 and 2500 mPa·s; and
the part (I) has a viscosity between 300 and 1000 mPa·s.

3. The use as claimed in claim 2, characterized in that:
said part (II) has a viscosity between 900 and 1800 mPa·s inclusive.

4. The use as claimed in claim 1, characterized in that in the part (I) of the formulation, the component (b) is present in a molar ratio between 5% and 15% inclusive of urethane functional group relative to all the isocyanate functional groups present in part (I).

5. The use as claimed in claim 4, characterized in that in part (I) of the formulation, the component (b) is present in a molar ratio of 10% of urethane functional groups relative to all the isocyanate functional groups present in part (I).

6. The use as claimed in claim 1, characterized in that in the part (II) of the formulation, the alkoxylated glycerol etherate (c) is of formula (C):
HO—(R₁13 O)ₙ—CH₂—CH(—(O—R₂)ₘ—OH)—CH₂—(O—R₃)ₚ—OH (C)
in which:
R₁, R₂ and R₃, being identical or different, independently of one another, represent a linear or branched (C₂-C₄) alkylene group; and
n, m and p, being identical or different, independently of one another, represent an integer between 1 and 6 inclusive.

7. The use as claimed in claim 6, characterized in that the compounds of formula (C) are such that:
R₁, R₂ and R₃, being identical, represent an ethylene group or an isopropylene group; and
n, m and p, being identical, represent an integer between 1 and 3 inclusive.

8. The use as claimed in claim 6, characterized in that the part (c) of part (II) of said resin comprises the compounds of formula (C) in which:
R₁, R₂ and R₃, being identical, represent an isopropylene group;
n, m and p, being identical, represent an integer between 1 and 3 inclusive; and
the ratio between the monomer form (n=m=p=1) and the oligomer forms (n=m=p>1) is between 100/0 and 90/10 inclusive.

9. The use as claimed in claim 1, characterized in that in part (II) of said resin, part (d) comprises at least one polyalkoxylated tertiary diamine tetraol and/or triol of formula (D):
R₄—N(R₅)—R₈—N(R₇)—R₆ (D)
in which:
R₄, R₅ and R₆, being identical or different, independently of one another, represent a group of formula (D1):
—(R₉—O)ᵤ—(R₁₀—O)ᵥ—H (D1)
in which:
R₉ and R₁₀, being identical or different, independently from one another, represent a group chosen from ethylene, n-propylene and isopropylene;
u and v, being identical or different, independently from one another, represent an integer between 0 and 3 inclusive, it being understood that u and v do not represent the value 0 at the same time;
R₇ represents a hydrogen atom or an R₄ group as defined previously; and
R₈ represents a linear or branched (C₂-C₄) alkylene group.

10. The use as claimed in claim 9, characterized in that the compounds of formula (D) are such that:
R₈ represents an ethylene group;
R₄, R₅ and R₆ are identical and as defined previously;
R₇ is as defined previously; and
R₉ and R₁₀ are different and as defined previously.

11. The use as claimed in claim 9, characterized in that part (d) of the part (II) of said resin comprises:
i. at least one polyalkoxylated tertiary diamine tetraol of formula (D) in which:
R₄, R₅, R₆ and R₇, being identical, each represent a group of formula (D1) in which:
R₉ represents an ethylene group;
R₁₀ represents an isopropylene group;
u and v, being identical or different, independently of one another, represent an integer between 1 and 3 inclusive;
R₈ represents an ethylene group;
ii. possibly one or more polyalkoxylated tertiary diamine triol(s) of formula (D) in which:
R₄, R₅ and R₆ each represent a group of formula (D1) in which:
R₉ represents an ethylene or isopropylene group;
R₁₀ represents an isopropylene or ethylene group;
u and v, being identical or different, independently of one another, represent an integer between 1 and 3 inclusive;
R₇ represents a hydrogen atom;
R₈ represents an ethylene group; and
iii. the ratio between (i) and (ii) is between 100/0 and 90/10 inclusive.

12. The use as claimed in claim 1, characterized in that in part (II), the ratio between part (c) and part (d) is between 70/30 and 95/5 inclusive.

13. The use as claimed in claim 12, characterized in that in part (II), the ratio between part (c) and part (d) is between 75/25 and 90/10 inclusive.

14. The use as claimed in claim 12, characterized in that in part (II), the ratio between part (c) and part (d) is equal to 80/20.

15. The use as claimed in claim 1, characterized in that the molar ratio between part (I) and part (II) of said resin is between 0.95 and 1.1 inclusive.

16. An optical lens substrate, characterized in that it is capable of being obtained from a thermosetting polyurethane resin as defined in claim 1, said resin having been molded then cured.

17. The substrate as claimed in claim 16, characterized in that it is coated with at least one layer such as, especially, an abrasion-resistant coating; an adhesion primer; an antireflection coating, antisoiling coating or polarizing coating.

18. The substrate as claimed in claim 16, characterized in that it is colored by conventional coloring techniques.

19. An optical lens, characterized in that it comprises a substrate as claimed in claim 16.

20. The optical lens as claimed in claim 19, characterized in that said lens is an ophthalmic lens.

21. A method for manufacturing an optical lens, characterized in that it comprises a step of manufacturing the substrate, in which parts (I) and (II) of the resin as defined in any one of claims 1 to 15 are mixed, at a temperature between 18° C. and 60° C., a mold suitable for manufacturing optical lenses is filled with the resin obtained, said mold-filling being carried out manually or mechanically, then the resin placed in the mold is cured, preferably between 80 and 130° C., and then an annealing step is carried out.

22. The manufacturing method as claimed in claim 21, characterized in that said step of mixing parts (I) and (II) of the resin is carried out at a temperature between 20° C. and 40° C.
